(19) United States
(12) Patent Application Publication
(10) Pub. No.: US 2012/0165450 A1
(43) Pub. Date: Jun. 28, 2012

(54) MALLEABLE MATERIAL

(76) Inventors: Ian R. Burrows, Brighton (GB); Rob Kaye, Macclesfield (GB)

(21) Appl. No.: 13/334,323

(22) Filed: Dec. 22, 2011

Related U.S. Application Data
(63) Continuation of application No. PCT/GB2010/051091, filed on Jul. 1, 2010.

(30) Foreign Application Priority Data
Jul. 2, 2009 (GB) 0911468.7

(51) Int. Cl. C08K 5/5419

(52) U.S. Cl. 524/261

(57) ABSTRACT

The invention relates to a malleable material which can be manipulated by a person such as a child, directly or via forming apparatus with the material substantially retaining the shape to which the same has been formed, following manipulation. The material is formed from a base formed from one or more silicone materials. In one embodiment the material includes a glow pigment which causes the material to fluoresce when exposed to light, such as UV or near UV light. In one embodiment the material includes a colour pigment which determines the condition of the material in a normal condition and, when a glow component is also provided, in addition to the material being caused to fluoresce, the colour of the material may also be caused to change colour.

### REFERENCE TO RELATED APPLICATIONS

This application is a continuation of PCT/GB2010/051091, filed 1 Jul. 2010, which is hereby incorporated by reference. This application claims priority from Patent Application No. GB 0911468.7, filed 2 Jul. 2009, which is hereby incorporated by reference.

The invention to which this invention relates is a material which is malleable in as much that the same can be manipulated by hand and, once manipulated to a particular shape or form by hand, is substantially retained in that shape or form until the same is next manipulated. In particular, the invention relates to the provision of a malleable material in a form which can be used as a plaything by a child either with the child using their hands to manipulate the material and/or apparatus to form the material into particular shapes.

The provision of malleable material as a plaything is well known and has been for sale successfully for a significant number of years. One conventional form of malleable material is a flour and water based product with the material components provided in a form such as to form a malleable material which is capable of use by the children. While this known product has been widely used for a period of years, there are inherent problems with the same.

A first problem is that the product, over time, can dry out unless the same is kept in sealed containers or bags. When the material dries out, it tends to crumble and separate thereby meaning that parts of the material can be rendered unusable as they are no longer malleable. Also, parts can become separated from the body of the material and be discarded which can cause mess and even damage to articles such as carpets, seats and the like as well as causing frustration in terms of having to clear the same up. This therefore typically means that, over time, the amount of usable malleable material reduces to such an extent that eventually, a new product has to be purchased. A further problem is that the material tends to be of a type which has tendencies to adhere to other articles which can make it difficult to remove and, even when removed, a residue of the material can often be left.

A yet further problem is that the material while it can be provided in a range of colours, has no ability to change in terms of the appearance of the same and, apart from mixing materials of different colours together, there is no ability for the child using the malleable material to alter the appearance of the same other than with regard to the shape.

The aim of the present invention is therefore to provide a malleable material which, in one embodiment, can be used as a plaything, and which is a form so as to be less susceptible to drying out, less susceptible to separation and leaving residues and furthermore, has at least one component of its appearance which can be altered in addition to the shape of the same.

In a first aspect of the invention there is provided a malleable material, said material formed with a base of one or more silicone components, said material manipulable by a person and or apparatus to change the shape of the same and which new shape is substantially retained and wherein the condition of at least one further characteristic of the appearance of the malleable material can be altered.

In one embodiment, the said characteristic which can be changed, is the fluorescence or glow of the material and/or the colour of the material.

In either case, typically the change in the characteristic is achieved by exposing the material to ultra violet (UV) light or near UV light or the like for a period of time whereupon the characteristic changes. Typically the said change in condition is thereafter viewable for a period of time. Typically, at the end of the said period of time, the said characteristic returns to its original form.

In one embodiment, the said malleable material includes a glow pigment component In addition, the said material includes a colour pigment component, with the colour pigment determining the colour of the material in its “normal” form and the glow pigment determining the colour of the material once exposed to UV light, as well as creating the glow effect of the material.

In one embodiment, the colour of the material in the normal condition is different to that of the material once exposed to the UV light.

In another embodiment, the colour is the same in both conditions. In either case, the fluorescence of the material changes between the normal condition and the condition created when the material is exposed to UV light.

Typically the degree of change in the fluorescence, can be controlled by controlling the proportion of the glow pigment and/or other pigment component which is included in the material and/or the degree of transparency of the base silicone components.

Typically, the fluorescence or glow intensity of the material once it has been exposed to the UV light is proportional to the duration of the glow effect or fluorescence, and this can be controlled by the selection of the quantities of the glow pigment component and other components within the material so as to tailor the material to meet specific usage requirements. In one embodiment the components are selected to provide a relatively rapid change from the normal appearance to the glow effect upon exposure to a relatively small amount of UV light.

Typically the glow effect is particularly apparent in darkness or shade.

Typically the material is non-toxic and therefore safe for use by children and is resistant to change upon exposure to high temperatures. In one embodiment the material is designed to be selectively tacky inasmuch that it will stick to relatively smooth surfaces but not to rough surfaces such as fabrics or the like.

In one embodiment material of different colours can be mixed together to provide a change in the colour of the material in its normal appearance, but also to change the colour of the material when it is glowing.

The provision of the malleable material having a base of silicone components rather than flour and water, means that the material is less susceptible to drying out over time whilst maintaining the malleability of the same and thereby increasing the life of the material.

Typically the material is provided in a form to be used by and safe for use by children.

In a further aspect of the invention there is provided a malleable material for use in child play said material manipulable by a child directly and/or via apparatus to allow the same to be changed in shape and/or separated from or joined to a portion of said material and wherein the material can be rendered to fluoresce or glow by exposing the same to UV light.

Typically, one of the visually distinctive appearances is for the material to fluoresce or glow. Typically this appearance is achieved by selectively exposing the material to UV light and the appearance then continues for a period of time following exposure.

In a yet further aspect of the invention there is provided a material, said material malleable and manipulable by a person and/or apparatus to change the shape of the same and which new shape is substantially retained and wherein at least one further component of the appearance of the malleable material can be altered.

In a further aspect of the invention, there is provided a malleable material, said material manipulable by a person and/or apparatus to allow the same to be changed in shape and, once manipulation has ceased, for the new shape to be substantially retained and wherein the material is formed from a base of one or more silicone components.

In one embodiment, the malleable material further includes any or any combination of the components of colour pigment; glow pigment; aero gel; and/or tartaric acid

In one embodiment at least one of the silicone components is substantially transparent.

Specific embodiments of the invention are now described with reference to the accompanying drawings wherein;

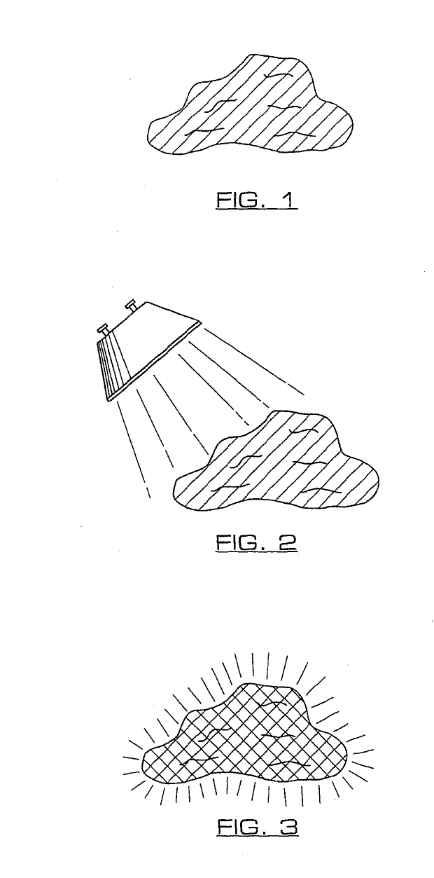

FIG. 1 illustrates a portion of malleable material in a first condition in accordance with one embodiment of the invention;

FIG. 2 illustrates an operation which can be performed on the portion of malleable material on FIG. 1 in accordance with the invention; and

FIG. 3 illustrates the appearance of the portion of material of FIGS. 1 and 2 following the performance of the operation of FIG. 2.

Referring firstly to FIG. 1, there is illustrated a portion of malleable material 2. Said material is of a “putty” like form in as much that the same can be manipulated by a user's hand by pressing the same so as to allow the shape of the same to be changed and altered to suit the user, typically a child's, requirements. The material can also be typically used in conjunction with apparatus in the form of moulds and/or forming tools. A mould can be provided to allow the malleable material to be pressed into the same and take the shape of the mould so as to form the portion of material into a particular shape such as a fish, animal, building, vehicle or the like. Tools can be provided to allow portions of the material to be cut off with the intention being to rejoin the material together into one portion once play has finished. It is also possible to use the malleable material in conjunction with apparatus which causes the same to be formed such as extrusion apparatus.

In accordance with the invention, the said malleable material portion 2, has a further characteristic which can be changed following an operation performed by the user.

In this case, the characteristic which changes is the colour and/or fluorescence (or glow) appearance of the material. In accordance with the invention, the portion as shown in FIG. 1, has a first colour in normal play conditions, with this colour being indicated by the hatching 6 in FIG. 1. The particular colour of the material in normal play conditions, is dependent upon the particular colour pigment which is included in the material composition and can be any of a range of available colour pigments.

In accordance with the invention, the malleable material portion 2 also includes a glow pigment component and the glow pigment may be of a similar colour to that of the colour pigment or may be a different colour to that of the colour pigment or may be a different colour pigment and again can be selected to suit particular requirements.

In order to change the condition of the characteristic, the user can place the portion of material 2 so that it is exposed to a source of UV light, such as for example, a room light bulb. The exposure of the material as shown in FIG. 2, to the UV light generated by the light bulb, for a period of time, for example 5-10 minutes, causes the “charging” of the glow pigment such that the colour and/or fluorescence of the portion material 2, changes to that illustrated in FIG. 3. The change in characteristic is particularly visible in darkness or shade.

In this particular embodiment of the invention, the glow pigment included in the material portion 2 is of a different colour to the colour pigment portion 2 such that, once the same has been exposed to the UV light in FIG. 2, both the colour and fluorescence of the material change as shown in FIG. 3 such that the same has a new colour 10 and fluorescence as indicated by the line 12. Thus, in accordance with the invention, in addition to changing the shape of the malleable material, the child can also change the colour and/or glow affect of the malleable material by performing a simple operation, thereby opening up a new range of possible play patterns and options for the child, and in turn, making the malleable material in accordance with this invention significantly more attractive for use than conventional malleable material.

After a period of time of the material having being placed back into normal play conditions, the glow affect of the malleable material and the change in colour of the same will decrease and eventually return to the condition shown in FIG. 1. However, the change in condition can be repeated as many times thereafter as required.

The intensity of the change and the intensity of fluorescence, can be selected by the selection of the particular quantities of the components used to form the malleable material. Typically, the greater the intensity of initial change, then the less the period of time over which the change is maintained and vice versa and therefore it will be appreciated that the particular intensity and the particular length of time of the change, can be selected to suit particular requirements for the use of malleable material as well as with respect to the cost of the components of the malleable material.

In addition to the particular glow pigment which is used and the quantity of the same, further components may also be added into the malleable material to allow the glow effect to be increased.

Preferably, the malleable material is formed from one or more silicone gum or rubber components and the use of silicone based materials rather than flour and water, means that the malleable material is less susceptible to drying out and separation whilst at the same time, maintaining the characteristics of malleability which makes the same attractive to children. Furthermore, the material is less likely to stick to other articles or leave residue thereon whilst, at the same time, being sufficiently tacky so as to allow the same to be stuck to relatively smooth surfaces in particular, such as, for example, glass and the like and, when separated therefrom, any residue which is left can be easily cleaned using water.

It should be appreciated that the particular components used and quantities of the same, can be adjusted to suit particular material requirements but an example of components used in accordance with the invention are for the silicone materials, Rhodorsil Gum and/or Elastosil, a Glow Pigment, a colour pigment such as, for example, Flourescent Pink, an aero gel and Tartaric Acid crystals.

As will be seen from the above, in this case the material can include two silicone gum components which are used in conjunction and if possible the gum components have as great a degree of transparency as possible in order to enhance the fluorescence and glow effect which is achieved. The glow pigment selected defines the appearance of the material when exposed to UV light while the colour pigment defines the colour of the malleable material in the normal daytime conditions. In addition to these pigments, an aero gel material is provided as well as tartaric acid crystals, both of which are included to further improve the fluorescence affect.

In an alternative embodiment the material does not include a glow pigment. One example of this form of the material includes a combination of base compounds formed of a rubber and a silicone based compound gum, an expanding agent such as that sold under the Registered Trade Mark Expancel 920 sold by Akzo Nobel, a colour pigment, glycerine and a selected scent.

In one embodiment the glow pigment may also be added to this compound.

There is therefore provided in accordance with the invention, a malleable material which can be used with conventional forming apparatus and tools and be manipulated by the user in the same manner as conventional material. However, in accordance with the invention, the material has improved characteristics in terms of use and furthermore, has at least one further characteristic which can be altered by operation of the user thereby enhancing its attractiveness. In particular the material of the type set out in the current application provides a glow effect which can be achieved rapidly and with great visual effect thereby allowing the material to be available to be used in two distinctively different forms. Furthermore the effect can be achieved whilst maintaining and indeed improving the malleability of the material in use.

1. A malleable material, said material formed with a base of one or more silicone components, said material manipulable by a person and or apparatus to change the shape of the same and which new shape is substantially retained and wherein the condition of at least one further characteristic of the appearance of the malleable material can be altered.

2. A material according to claim 1 wherein the characteristic which is altered is the fluorescence or glow of the material and/or the colour of the material.

3. A material according to claim 2 wherein the change of the characteristic is achieved by exposing the material to ultraviolet light or near ultraviolet light for a period of time.

4. A material according to claim 1 wherein the alteration in the condition is viewable for a period of time.

5. A material according to claim 4 wherein at the end of said period of time the said characteristic returns to its original form.

6. A material according to claim 1 wherein the material includes a glow pigment component.

7. A material according to claim 6 wherein the material includes a colour pigment component which determines the colour of the material in its normal form and the glow pigment determines the colour of the material once exposed to UV light.

8. A material according to claim 7 wherein the colour of the material in the normal condition is different to that of the material once exposed to the UV light.

9. A material according to claim 7 wherein the colour is the same in the normal and altered condition.

10. A material according to claim 1 wherein the fluorescence of the material changes between the normal condition and the condition created when the material is exposed to UV light.

11. A material according to claim 10 wherein the degree of change in the fluorescence is controlled by controlling a proportion of the glow pigment and/or colour pigment component which is included in the material and/or the degree of transparency of the base silicone components.

12. A material according to claim 1 wherein the fluorescence or glow intensity of the material once it has been exposed to ultraviolet light is proportional to the duration of the glow effect or fluorescence being visible.

13. A material according to claim 1 wherein the material is non toxic and resistant to change upon exposure to high temperatures.

14. A material according to claim 1 wherein the material includes a scent.

15. A material according to claim 1 wherein the material includes glycerine to soften the material.

16. A material according to claim 1 wherein the material includes a combination of base compounds formed of a rubber and a silicone based compound gum, an expanding agent, a colour pigment, glycerine and a selected scent.

17. A material according to claim 1 wherein the material includes a combination of Rhodorsil Gum and Elastosil, a glow Pigment, a colour pigment, an aero gel and Tartaric Acid crystals.

18. A malleable material for use in child play, said material manipulable by a child directly and/or via apparatus to allow the same to be changed in shape and/or separated from or joined to another portion of said material and wherein the material is rendered to fluoresce or glow by exposing the same to UV light.

19. A material, said material malleable and manipulable by a person and/or apparatus to change the shape of the same and which new shape is substantially retained and wherein at least one further component of the appearance of the malleable material can be altered.

20. A malleable material, said material manipulable by a person and/or apparatus to allow the same to be changed in shape and, once manipulation has ceased, the new shape is substantially retained and wherein the material is formed from a base of one or more silicone components.

21. A material according to claim 20 wherein the material includes a combination of the components of colour pigment, glow pigment, aero gel and tartaric acid.

22. A material according to claim 20 wherein the material includes a combination of the components of colour pigment, tartaric acid and at least one silicone material.

23. A material according to claim 20 wherein at least one of the silicone components is substantial transparent.
